(19) United States
(12) Patent Application Publication
(10) Pub. No.: US 2023/0380640 A1
(43) Pub. Date: Nov. 30, 2023

(54) Wall Mounted Feminine Hygiene Products Holder

(71) Applicant: Tonya Stevenson, Black Jack, MO (US)

(72) Inventor: Tonya Stevenson, Black Jack, MO (US)

(21) Appl. No.: 17/829,105

(22) Filed: May 31, 2022

(51) Int. Cl. A47K 5/18; B65F 1/14

(52) U.S. Cl. CPC A47K 5/18; B65F 1/14; A47K 2201/02; B65F 2001/1676

(57) ABSTRACT

The disclosed kitty boxz is the only product of its kind that is designed specifically to neatly and discreetly house sanitary hygiene products in the bathroom, and can be easily mounted to free up counter space. This unprecedented product is uniquely designed to be slim, nontransparent, modern and stylish to serve as an important and useful complement to any home bathroom decor space.

### BACKGROUND

Many women use multiple types of feminine hygiene products like pads, tampons, wipes, liners, and/or panties, but storing such items discreetly in a bathroom can be a real hassle. Considering feminine care products can easily get disorganized and often take up a vast amount of space in bathroom cabinets or on countertop spaces, these items can easily create a cluttered and messy bathroom environment. There have been no products available as original equipment or as an aftermarket to address this problem.

A wall mounted apparatus that can effectively and discreetly keep feminine hygiene products organized, is not being met by any known device or system at present. There have been no products available as original equipment or as an aftermarket to address this problem either.

### SUMMARY OF THE INVENTION

The main purpose of the feminine hygiene products holder is to provide users with a sleek and discreet sanitary feminine hygiene product holder that can be mounted in home bathrooms.

A container comprising a recessed top side configured to receive a cellular phone and adjoining a back, a front and two sides thereof; a door configured to cover a portion of the front; a pull-out drawer configured to occupy a portion of an inside volume thereof; and a hinge disposed between a front side of the pull-out drawer and a back side of the door configured to transfer a force on the door onto the pull-out drawer in embodiments.

### BRIEF DESCRIPTION OF THE DRAWINGS

FIG. 1 is a front perspective view of the feminine hygiene products holder with closed drawers and an open pull-down door in accordance with an embodiment of the present disclosure.

FIG. 2 is a front perspective view of the feminine hygiene products holder with open drawers and an open pull-down door in accordance with an embodiment of the present disclosure.

FIG. 3 is a front perspective view of the feminine hygiene products holder with a closed pull-down door in accordance with an embodiment of the present disclosure.

FIG. 4 is a back perspective view of the feminine hygiene products holder in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

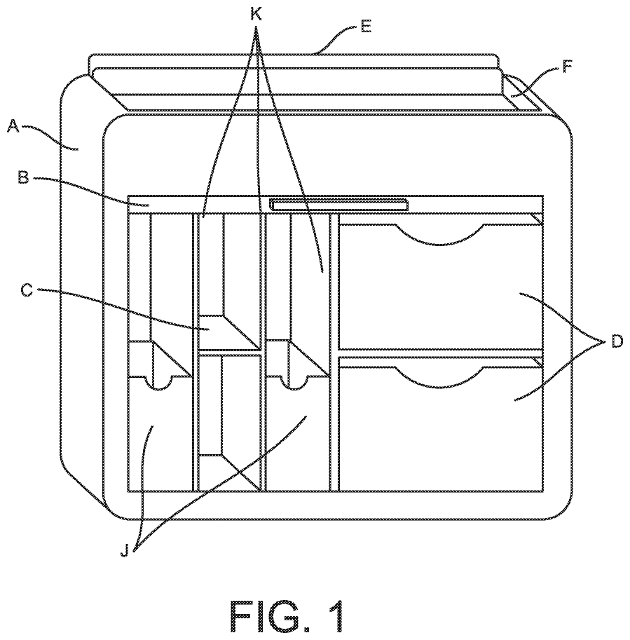

FIG. 1 is a front perspective view of the feminine hygiene products holder with open drawers and an open pull-down door showing: wall-mounted hygiene cabinet referenced as A, pull-down shutter door referenced as B, shelf referenced as C, pull-out drawers referenced as D, phone holder referenced as E, lowered top platform referenced as F, in accordance with an embodiment of the present disclosure. Drawers J are a compact size for smaller items as embodied in the present disclosure. The drawers D and J are flush with the shelf C and the dividers K in a closed position but extend therefrom in an open position enabled by the pull-down shutter door B position.

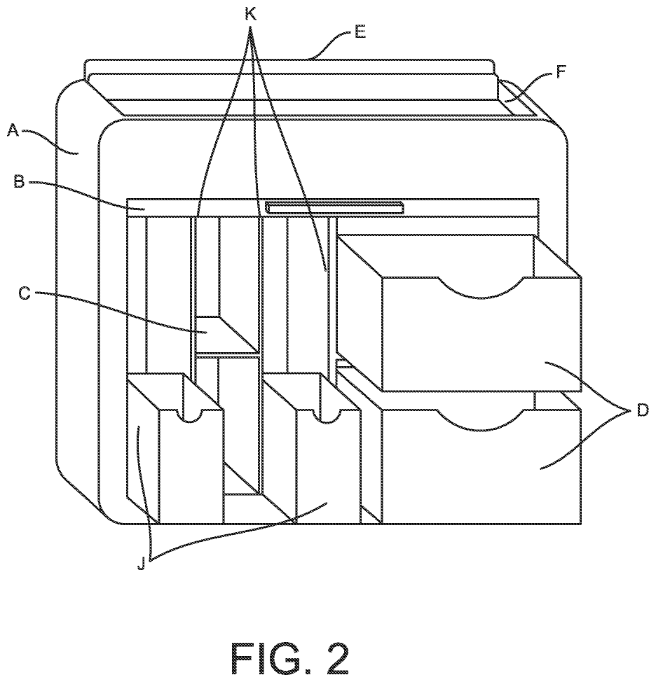

FIG. 2 is a front perspective view of the feminine hygiene products holder with open drawers and an open pull-down door in accordance with an embodiment of the present disclosure. The wall-mounted hygiene cabinet referenced as A, pull-down shutter door referenced as B and optional swing doors, shelf referenced as C, pull-out drawers referenced as D, phone holder referenced as E, lowered top platform referenced as F, in accordance with an embodiment of the present disclosure. Drawers J are a compact size for smaller items as embodied in the present disclosure. The drawers D and J are flush with the shelf C and the dividers K in a closed position but extend therefrom in an open position enabled by the pull-down shutter door B position.

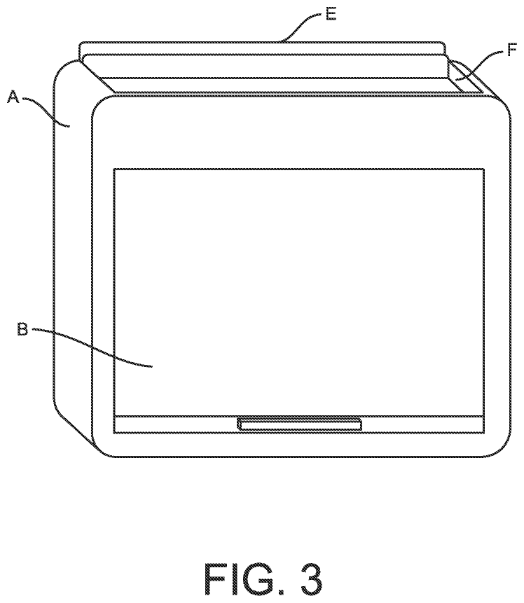

FIG. 3 is a front perspective view of the feminine hygiene products holder with a closed pull-down door showing: wall-mounted hygiene cabinet referenced as A, pull-down shutter door referenced as B, phone holder referenced as E, and lowered top platform referenced as F in accordance with an embodiment of the present disclosure. The shelf C and the dividers K are recessed from the pull-down shutter B in a closed position.

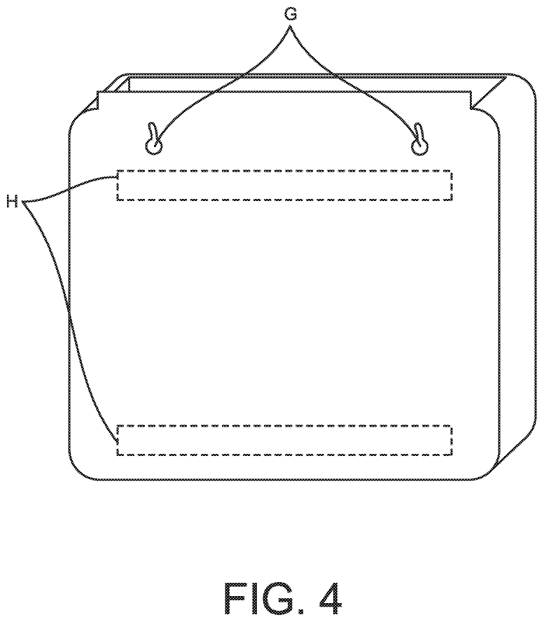

FIG. 4 is a back perspective view of the feminine hygiene products holder showing: holes to mount cabinet referenced as G, and optional adhesive strips referenced as H in accordance with an embodiment of the present disclosure.

The present disclosed feminine hygiene product holder, also known as the “Kitty Boxz” offers a modern accessory that not only allows individuals to neatly store and organize their personal hygiene items, but also provides quick and easy access to them, when needed. Expanding on the initial design of an average cabinet, the Kitty Boxz introduces a novel feminine hygiene item holder that can be conveniently mounted to the wall or onto the side of bathroom vanity. The Kitty Boxz is strategically designed with specialized compartments for wipes, feminine hygiene products such as pads, a deodorant compartment, and even a trash compartment, where users will be able to dispose of any wrappers or discarded sanitary items.

Furthermore, this storage option offers three style/function units titled: the Felix, the Leo and the Milo, with each possessing a configuration to hold items that the user may frequently rely on permitting the consumer to purchase the design that best meets their mensuration management preference. This innovative, top-quality product offers a fully operational cabinet that guarantees individuals are able to house all of their sanitary hygiene products in one convenient location allowing for both a more enjoyable and convenient bathroom experience. Further embodiments are contemplated per the present application and product development.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A container dispenser comprising:
a recessed top side configured to receive a cellular phone and adjoining a back, a front and two sides thereof;
a door configured to cover a portion of the front; and
a pull-out drawer configured to occupy a portion of an inside volume thereof.

2. The container dispenser of claim 1, further comprising a pair of swing doors configured to cover a front of the container dispenser.

3. The container dispenser of claim 1, further comprising a plurality of pull-out drawers configured in a volume of the container dispenser.

4. The container dispenser of claim 1, wherein the recessed top is configured across a width and a length of a top side of the container dispenser.

5. The container dispenser of claim 1, further comprising a plurality of mounting holes defined in the back of the container dispenser.

6. The container dispenser of claim 1, further comprising an adhesive strip configured to resist a force directed parallel to the back of the container dispenser.

7. The container dispenser of claim 1, wherein the pull-out drawer is lined with a sealant configured to seal in a scent therein for a trash content.

8. The container dispenser of claim 1, wherein the force is a pull force on the swing door.

9. The container dispenser of claim 1, wherein the force is a push force on the swing door.

10. The container dispenser of claim 1, wherein the door is a swing door.

11. The container dispenser of claim 1, wherein the door is a pull-down shutter door.

12. The container dispenser of claim 1, wherein the container dispenser is a wall-mount hygiene cabinet.

13. The container dispenser of claim 1, further comprising a plurality of pull-out drawers.

14. The container dispenser of claim 1, further comprising a shelf in a volume thereof.
